(19) United States
(12) Patent Application Publication
(10) Pub. No.: US 2008/0210386 A1
(43) Pub. Date: Sep. 4, 2008

(54) ROLLER SHUTTER

(75) Inventor: Dirk Neuhaus, Ludenscheid (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Adolf Seuster GmbH & Co. KG, Ludensheid (DE)

(21) Appl. No.: 11/943,393

(22) Filed: Nov. 20, 2007

(30) Foreign Application Priority Data
Nov. 20, 2006 (DE) 202006017619.5

(51) Int. Cl. E06B 9/15

(52) U.S. Cl. 160/133

(57) ABSTRACT

A roller shutter comprising a door leaf for rolling up, forming a multi-layered coil with multiple slats crosswise at a right angle with longitudinal axes toward the opening movement extending horizontally, the slats pivotably connected by an engaging assembly extending over the greater part of the slat length with respect to pivot axes extending parallel to their longitudinal axes, and the door leaf with engaging devices with at least one engaging device between two adjacent slats, a first engaging device arranged at its leading edge during the opening movement creating articulated connection with an adjacent slat, and a second engaging device arranged at its trailing edge during the opening movement to create an articulated connection with another adjacent slat, wherein at least one engaging device is provided with a separate engaging element capable of being fixed to the slat with positive locking, with force fit and/or with substance-to-substance bond.

### CROSS REFERENCE TO RELATED APPLICATIONS

The present application claims international priority under 35 U.S.C. § 119 to co-pending German Utility Patent Application No. 20 2006 017 619.5 filed Nov. 20, 2006, entitled “Rolltor” the entire content and disclosure of which is hereby incorporated by reference in its entirety.

### FIELD OF THE INVENTION

The present invention relates to a roller shutter with a door leaf.

### BACKGROUND

Roller shutters are used as closures for garages and industrial buildings. The door leaf, in its closed position, is usually arranged in an approximately vertical plane, with the lower edge of the door leaf resting against the bottom of the opening to be closed thereby and being pulled upward, starting from a closed position, with an opening motion in the opposite direction of gravity, whereby the door leaf is rolled up to form a multi-layered coil. It is possible for the multi-layered coil to be arranged on a winding shaft which is usually arranged behind the ledge forming the top edge of the opening to be closed.

In a roller shutter described, for example, in EP 0 531 327 B1, the roller shutter leaf is accommodated, in the opened position, with its lateral edges in spiral guide rails and is supported by them. To create an articulated connection between the individual slats of a roller shutter leaf, the slats are equipped with engaging devices in the form of so-called insertion profiles at their edges facing their respective adjacent slats. These profiles are hook-shaped when viewed in a sectional plane extending at a right angle to the longitudinal axes of the slats and they interlock in order to create the articulated connection. The hook-shaped profiles are formed in one piece with the slats during the manufacture of the slats in the course of extruding machine processes and/or rolling processes. Then adjacent slats can be pushed into each other to produce the door leaf and threaded into the guide rails serving to guide the movement of the door leaf.

This type of assembly is associated with considerable expense because the required assembly length is equivalent to approximately twice the length of the slats. In addition, during the movement of the roller shutter leafs of the type described above, there can be considerable noise development and a transfer of vibrations to the building comprising the opening to be closed.

To solve these problems, EP 0 531 327 B1 suggests a further development of the known door leaves, in which the slats are jointedly connected with each other by means of strap hinges attached at the lateral edges of the slats, thereby avoiding profile joints. In order to ensure sufficient sealing properties and a sufficient lateral stability of the door leaf in the closed position, these roller shutters are further provided with a sealing strip connecting adjacent slats with each other and placed between the individual strap hinges attached to the lateral edges of the slats.

The installation of these roller shutters also poses considerable problems because the individual slats first have to be connected with each other by means of the sealing strips and then have to be placed onto the strap hinges.

### SUMMARY

In view of the problems of the state of the art described above, the invention is based on the technical problem of providing a roller shutter that is easy to install. The present invention relates to a roller shutter with a door leaf capable of being rolled up, starting from a closed position and in the course of an opening movement, to form a multi-layered coil and comprising a multitude of slats extending crosswise, specifically approximately at a right angle with their longitudinal axes in the direction of the opening movement and usually extending horizontally, with the slats being pivotably connected with each other by means of an engaging assembly extending at least over the greater part of the slat length with respect to pivot axes extending parallel to their longitudinal axes, and comprising at least one engaging device between two adjacent slats, a first engaging device arranged at its leading edge during the opening movement serving to create the articulated connection with an adjacent slat, and a second engaging device at its trailing edge during the opening movement, serving to create an articulated connection with another adjacent slat.

In accordance with the invention, this problem is solved by using a further development of the known roller shutters, wherein at least one engaging device arranged at an edge of the slats is provided with a separate engaging element that is capable of being fixed with positive locking, with force fit and/or with substance-to-substance bond to the slat, i.e., is not designed in one piece with the slat.

Within such an arrangement, it is possible to first cause the engaging element to engage with the engaging device of an adjacent slat and then to attach said engaging element to the slat, with the attachment being effected, for example, by clipping the attachment element onto the slat in a direction extending at right angles to the longitudinal direction of the slat and preferably also at right angles to the opening movement, i.e., vertically to the door leaf in the closed direction. This makes it possible to save installation space and to simplify the installation significantly.

In an especially preferred embodiment of the invention, the engaging element is made of a material that is optimized with respect to the noise development usually occurring with constructions of this type, while the slat itself may be made of a material optimized with respect to the desired total stability, such as, e.g., aluminum or steel. To produce a connection with positive locking between the engaging element and the slat, the engaging element may be provided with at least one attachment strip capable of being inserted into a groove-shaped receptacle of the slat extending in the longitudinal direction of the slat. In this arrangement, the direction of insertion advantageously extends vertically to the longitudinal direction of the slat and, especially preferably, also vertically to the direction of the opening movements of the slat in the installed state.

An especially reliable fixing of the engaging elements to the slat can be achieved by having at least one attachment strip which has a hook profile in a section plane running vertically to the longitudinal axis and/or at least one receptacle which has a profile designed for the fixing with positive locking of the hook profile.

For this purpose, the groove-shaped receptacle may be provided, for example in the area of the groove opening, with at least one, preferably two securing strips narrowing the groove opening in a direction running at right angles to the longitudinal axis of the slat.

To create the desired articulated connection, at least one engaging element of a roller shutter in accordance with the invention, as well as the engaging devices of conventional roller shutters, may be provided with a hook segment extending in the direction of an adjacent slat and engaging into a hook segment arranged on the adjacent slat in a section plane running vertical to the longitudinal axis of the slat. During the installation, the hook segments may first be caused to engage and then the engaging element may be attached, for example, with positive locking, to one of the slats.

An especially tight sealing of the opening may be achieved by providing at least one sealing element extending in the longitudinal direction of the slat. Such a sealing element may be arranged, for example, in a groove in a slat arranged on a side of a hook segment facing the exterior side of the door leaf, and it can be caused to rest against an adjacent slat, at least in the closed position of the door leaf, with a sealing area preferably designed as a hollow profile. The use of sealing elements between adjacent slats is expedient especially in the event that the engaging device comprises two or more engaging elements arranged side by side at a distance in the longitudinal direction of the slat in order to provide a tightly sealed door closure even in the area of the gap between the individual engaging elements.

In an especially preferred embodiment of the invention, at least one sealing element is arranged on a boundary surface of a hook segment facing the exterior side of the door leaf, implemented, for example, in the form of a soft sealing lip additionally injection-molded to the hook segment, and said sealing element is capable of being inserted, in the course of a pivot movement with respect to the pivot axis, into a gap formed between adjacent slats, whereby it comes to rest on a boundary surface of the adjacent slat.

Just like conventional roller shutters, the roller shutter in accordance with the invention may also be provided with a drive motor operable to move the door leaf between the closed position and the open position. It can, for example, also be contemplated to drive a winding shaft with the drive motor and to wind up the door leaf onto the winding shaft in the course of the opening movement. In view of the kinematic problems arising in this process, it has been found to be advantageous, however, when, during the opening movement, the door leaf is pushed into guide rails arranged behind the ledge of the opening, running in a spiral manner and serving to accommodate the lateral edges of the slats and/or guide rollers arranged at the lateral edges of the slats in the opened position, so as to prevent the polygon effect which occurs during the coiling onto a winding shaft and which is responsible for the noise and vibration development. In this embodiment of doors in accordance with the invention, it has been found to be particularly advantageous if the drive motor is coupled to the door leaf via a preferably continuously revolving pull device, with the pull device being coupled to the generally lower quarter of the door leaf which trails during an opening movement, specifically to the slat of the door leaf that is bottommost in the closed position and that generally rests against the bottom of the opening to be closed, if necessary via a bottom seal.

Using the above-described arrangement of roller shutters in accordance with the invention, it is not only possible to facilitate the installation, but it is also possible to reduce the noise and vibration development to such an extent that door leaf movements at considerable speeds are made possible. However, in the course of these door leaf movements, it is still possible for the individual hook segments of the engaging devices to contact each other when the door leaf is pushed into the spiral guide rail by a drive device coupled to the bottommost door leaf slat. This results in a considerable noise and vibration development which limits the opening speed.

A further increase of the opening speed of roller shutter leaves having slats connected with each other via corresponding engaging devices becomes possible when at least one spacer element, ensuring a preset distance between the adjacent slats or engaging devices attached thereto in the direction of the opening movement, is arranged on at least one slat in order to prevent a grinding contact of adjacent engaging devices in the course of the opening or closing movement.

In this case, the spacer element may be made of a high quality and highly resilient plastic optimized with respect to the noise and vibration development to be prevented.

The spacer element of roller shutters in accordance with the invention can also be designed as a separate element that is capable of being fixed to the slat with positive locking, with force fit and/or with substance to substance bond, with the spacer element as well as the engaging element possibly comprising at least one attachment strip which is capable of being inserted into the groove-shaped receptacle extending in the longitudinal direction of the slat and, advantageously, which is capable, just like the engaging element, of being clipped onto to slat in a direction extending at right angles to the longitudinal direction of the slat and at right angles to the direction of the opening movement. Just like the attachment strip of the engaging element, the attachment strip of the spacer element may be provided with a hook profile in a section plane extending at a right angle to the longitudinal axis of the slat, and it can comprise at least one profile serving to fix the hook profile with positive locking.

In an especially preferred embodiment of the invention, both at least one engaging element and at least one spacer element are arranged at least one edge of at least one slat. Then the grooves provided in the slats for the attachment of the spacer elements can also be used to attach the spacer element.

It has been found to be particularly advantageous when at least one spacer element is fixed in the longitudinal direction of the slats next to an engaging element, specifically at a lateral slat edge. When fixing the spacer element to a lateral slat edge, the spacer element can also be used as a support element on the spiral guide rails so that the slats rest on these spiral guide rails only via the spacer element. With doors having a particularly large width of e.g., 5 m or more, it has been found to be especially advantageous to have the spacer elements arranged not only on the lateral edges of the slats, but also in the central area of the slats. For this purpose, the spacer elements may also be placed between the individual engaging elements in the longitudinal direction of the slats. Thus, in this embodiment of the invention, an engaging device formed by engaging elements comprises, in the longitudinal direction of the slat, two or more engaging elements arranged next to each other at a distance equivalent to at least the width of a spacer element.

### BRIEF DESCRIPTION OF THE DRAWINGS

In the following, the invention is explained with reference to the drawing, which is explicitly referred to with respect to all particulars which are essential to the invention and are not set forth in detail in the description.

FIG. 1 is a schematic representation of a roller shutter in accordance with the invention;

FIG. 2 is a detail representation of the drive device for the roller shutter shown in FIG. 1;

FIG. 3 is a further detail representation of the drive device for the roller shutter shown in FIG. 1;

FIG. 4 illustrates a guide rail element serving to accommodate the roller shutter leaf shown in FIG. 1 in the opened position;

FIG. 5 is a representation of the articulated connection between the individual slats of the roller shutter leaf shown in FIG. 1; and

FIG. 6 is a representation of an articulated connection between individual slats of a roller shutter in accordance with a further embodiment of the invention.

### DETAILED DESCRIPTION

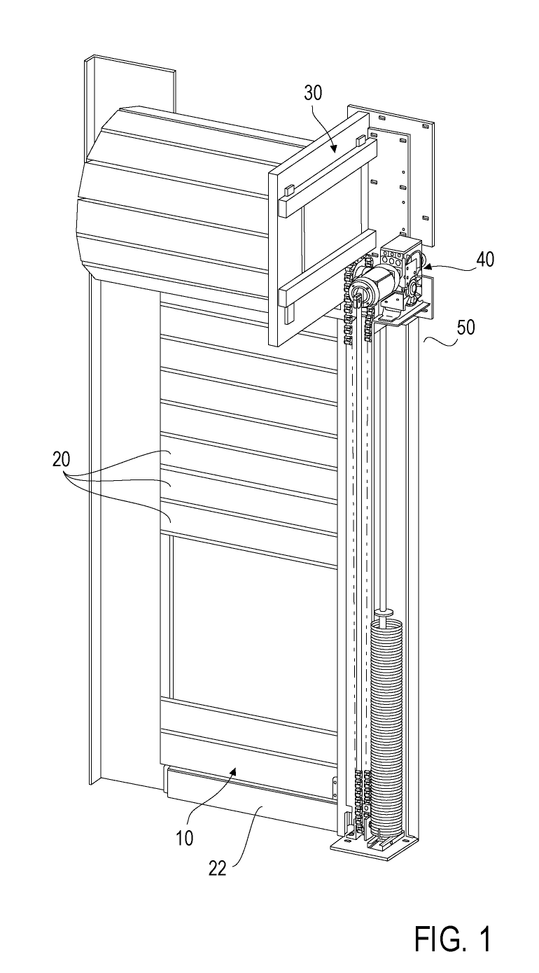

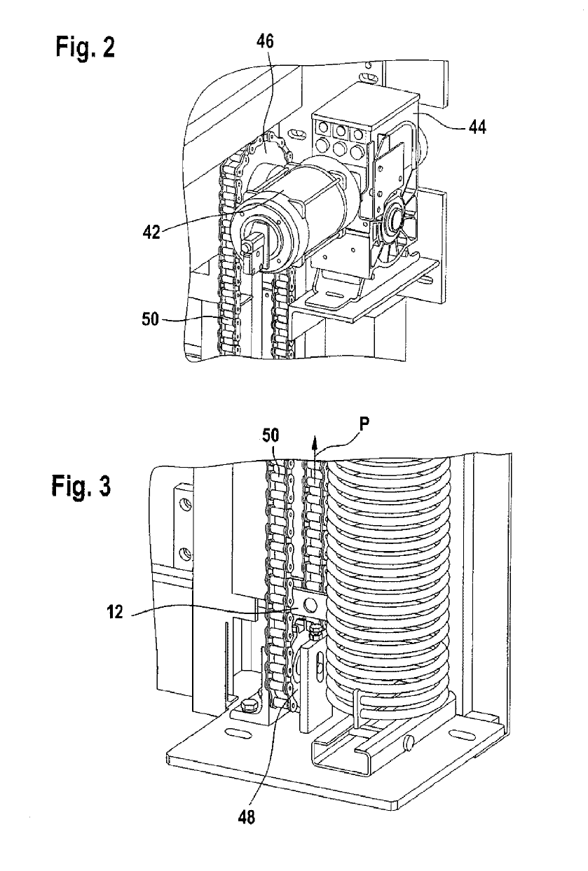

The roller shutter shown in FIG. 1 comprises a door leaf, as a whole referred to as 10, which is formed by a multitude of slats interconnected in a pivotable manner with respect to horizontally extending pivot axes; further a drive device 40 and a guide rail arrangement 32 arranged on a carrier plate 30 and serving to accommodate the lateral edges of the roller shutter or respective guide rollers in the opened position in which the door leaf—as can be gathered from FIG. 1—is wound up to form a multi-layered coil. In the opened position, the lateral edges of the slats 20 or the respective guide rollers of the door leaf 10 are accommodated in the spiral guide rail arrangement 32 provided with the carrier plate 30 (cf. FIG. 4).

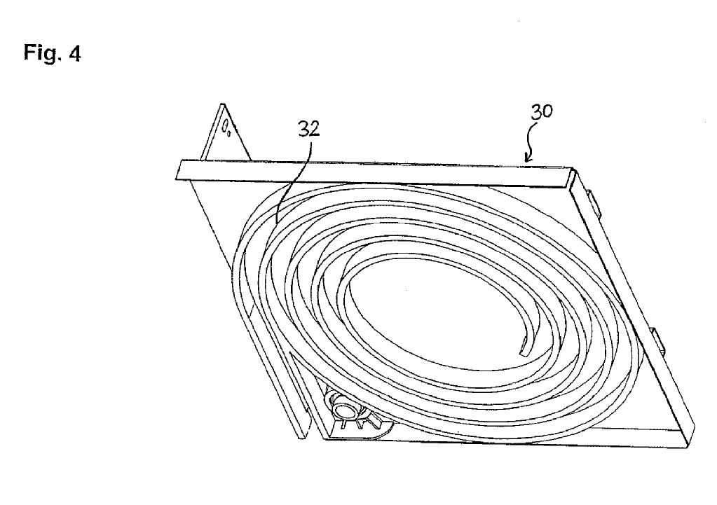

The drive device of the roller shutter shown in FIG. 1, referred to as a whole as 40, comprises an electric motor 42, which is coupled to a sprocket wheel 46 via a gear assembly 44, with said sprocket wheel being pivotable around a pivot axis running parallel to the longitudinal axis of the slats 20 by means of the electric motor 42. The sprocket wheel 46 is passed over by a chain 50, which passes over another sprocket wheel 48 in the area of the bottom of the opening to be closed by the door leaf 10. This additional sprocket wheel 48 is pretensioned by means of a tensioning device, which is not shown in detail, in such a way that the chain passing over the sprocket wheels 46 and 48 always remains in a tensioned state. By means of a connecting link 12 shown in FIG. 3, the chain 50 is coupled with the slat 20 of door leaf 10, which is the bottommost slat in the closed state. Starting from the closed position, in which the bottommost slat 20 of the door leaf 10 rests on the bottom of the opening to be closed by the door leaf 10 via a bottom seal 22, the door leaf 10 is moved in the course of a circulating movement of the chain 50 in the direction indicated by the arrow P (cf. FIG. 3) into the closed position, in which it is wound up within the guide rail 32 attached to the carrier plate 30 (cf. FIG. 4) to form a multi-layered coil.

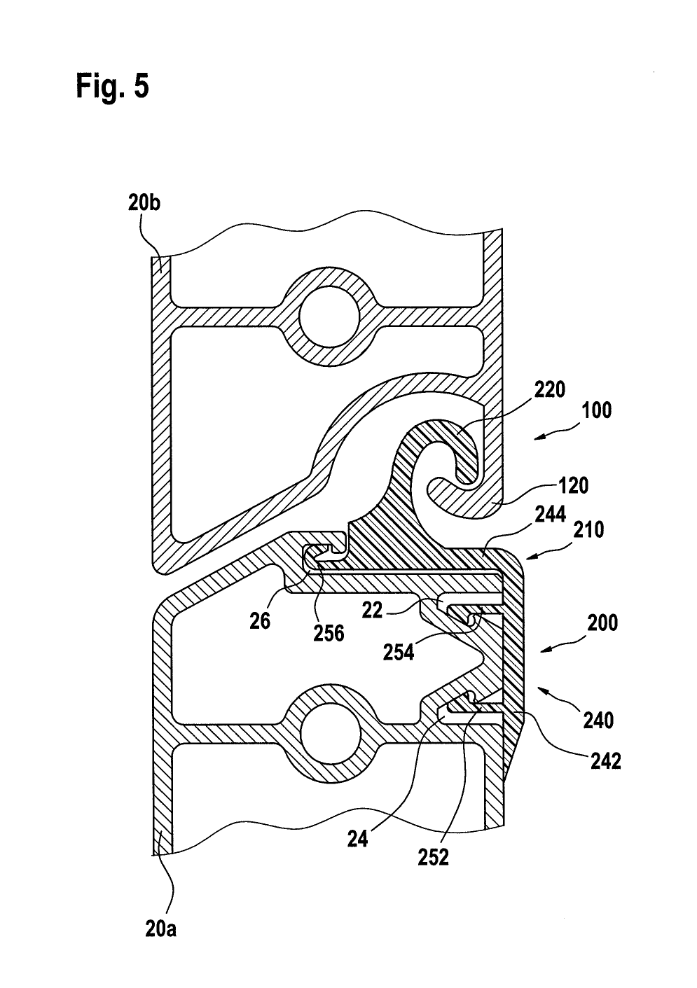

In the embodiment, shown in FIG. 5, of an articulated connection between two successive slats 20a and 20b of a door leaf of a roller shutter in accordance with the invention, the top slat 20b shown in FIG. 5 has a one-piece design with an engaging device 100, which is essentially formed by an engaging strip 120 extending approximately over the entire length of the slat 20b and having a hook-shaped profile, i.e., a hook segment, in the section plane extending vertically to the longitudinal axis of the slat 20b. The engaging device 200 at the bottom slat 20a in FIG. 5 comprises an engaging element referred to as a whole as 210, which is designed as a separate component and which is capable of being attached to the slat 20a with positive locking.

The engaging element 210 is overall made in one piece and comprises an angle profile 240 with two legs 242 and 244 extending in the longitudinal direction of the slat 20a and together enclosing an angle of preferably 90°, with leg 242 covering the top area of an inner boundary surface of the slat 20a facing the space to be closed thereby in the closed position of the door leaf, while the leg 244 covers a rear area of the upper edge of the slat 20a in the closed position. A hook segment 220, which extends in the longitudinal direction of the slat 20a and which engages into the hook segment 120 is formed on the top boundary surface of the leg 244.

On the leg 242, two attachment strips 252 and 254 extending approximately parallel to the leg 244 are formed, with said attachment strips 252 being accommodated in the receptacle grooves 22 or 24 in the top area of the inner boundary surface of slat 20a.

The attachment strips 252 and 254 have a hook profile which engages into a hook profile of complementary design of the receptacle grooves 22 or 24 with positive locking. The width of the attachment strips 252 or 254 is smaller than the width of the receptacle grooves 22 and 24, and the distance between the attachment strips 252 and 254 is adjusted to the distance between the receptacle grooves 22 and 24 in such a way that the attachment strips 252 and 254 are first pushed apart during the insertion of the receptacle grooves 22 and 24 and then the hook profiles engage behind the receptacle grooves 22 and 24. The attachment strip 256, arranged on the side of the hook segment 220 which is facing away from the inner boundary surface of the slat 20a, is also designed in the form of a hook profile and accommodated in a receptacle groove 26 with a hook profile of complementary design. The width of the hook profile 256 is also smaller than the width of the receptacle groove 26.

During the assembly of the engaging element 210 to the slat 20a, as shown in FIG. 5, the engaging element 210 is pushed onto the slat 20a in a direction extending parallel to the surface normal to the inner boundary surface of the slat 20a, with the attachment strips 252, 254 and 256 engaging into the receptacle grooves 22, 24 and 26, first giving way to the profiles within the receptacle grooves 22, 24 and 26 and then engaging behind them to create a connection with positive locking.

In the embodiment of the invention shown in FIG. 5, the slats 20a or 20b may be made of extrusion molded aluminum, while the engaging element 210 may be made of plastic.

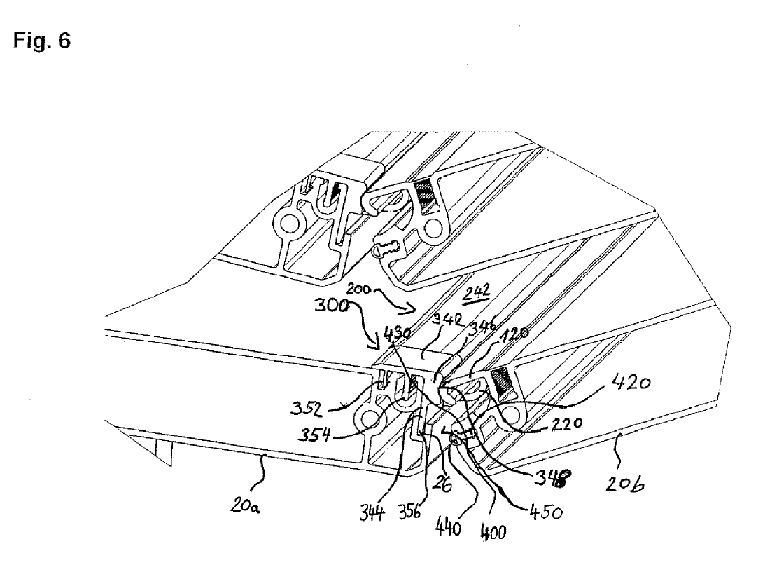

In the embodiment of the invention shown in FIG. 6, there is a spacer element 300 attached in addition to the engaging device 200 at the edge of the slat 20a shown on the right side in FIG. 6. The spacer element 300 is attached in the direction of the longitudinal axis of the slat 20a next to the engaging device 200 in the area of the lateral edge of the slat 20a. Like the engaging element 200, the spacer element 300 is also essentially designed in the form of an angle profile with a first leg 342 extending approximately parallel to the leg 242 and a second leg 344 also extending approximately parallel to the leg 344 of the engaging device 200.

In the inner area facing the space to be closed by the door leaf, the leg 344 includes a raised ledge 346, whose upper boundary surface facing the adjacent slat 20b comprises a recess whose form is adapted to the vertex of the hook segment 120 at the engaging device 200 of the slat 20b, producing a sliding contact of the vertex of the hook segment 120 with the boundary surface of the recess 348 when the door leaf is moved from the closed position to the opened position.

The spacer element 300 is wholly made of a highly resilient special plastic which is optimized in terms of the noise and vibration development to be prevented. Like the engaging element 210, the spacer element 300 is attached to the slat 20a with positive locking. For this purpose, two support strips 352 resp. 354 extending approximately parallel to the leg 344 are provided on the leg 34, which also have a hook profile design and which may be inserted into the respective receptacle grooves of the slat 20a. In addition, at the edge facing away from the leg 342, the leg 344 is provided with a projection accommodated in a receptacle 26. This prevents tipping of the spacer element 300 relative to the slat 20a with respect to a direction extending parallel to the longitudinal axis of the slat 20a.

In the embodiment of the invention shown in FIG. 6, a sealing element, as a whole referred to as 400, is provided at the edge of the slat 20b facing the slat 20a. This sealing element 400 is accommodated in a receptacle groove 420 at the bottom edge of the slat 20b and includes an attachment area 430 provided with a barbed hook profile and arranged in the receptacle groove 420, as well as a sealing area 440 with a hollow profile, which rests on the support surface 450 of the slat 20a in the closed position of the door leaf. In the embodiment of the invention shown in FIG. 6, the sealing area 440 and the attachment area 430 have a one-piece design.

The invention is not restricted to the embodiments explained with reference to the drawing. It is also contemplated, for example, to provide a sealing lip in the area of the hook segment 220. It is also possible for two or more attachment elements to be attached to the edge of a slat next to each other at a distance. It is also contemplated to attach the engaging element by means of more or less than three attachment strips to the slats, with an attachment with force fit and/or with positive locking also being contemplated.

Other drive solutions are also contemplated involving the door leaf being wound up to a winding shaft, with the possibility of having the drive system driving the winding shaft directly, thereby avoiding a revolving chain.

1-20. (canceled)

21. A roller shutter comprising a door leaf configured for rolling up starting from a closed position and in the course of an opening movement, to form a multi-layered coil, the door leaf comprising a multitude of slats extending crosswise approximately at a right angle with their longitudinal axes in a direction of the opening movement and extending horizontally, the slats being pivotably connected with each other by means of an engaging assembly extending at least over the greater part of the slat length with respect to pivot axes extending parallel to their longitudinal axes, and the door leaf further comprising engaging devices with at least one engaging device between two adjacent slats, a first engaging device being arranged at its leading edge during the opening movement serving to create the articulated connection with an adjacent slat, and a second engaging device being arranged at its trailing edge during the opening movement, serving to create an articulated connection with another adjacent slat, wherein at least one engaging device is provided with a separate engaging element that is capable of being fixed to the slat with positive locking, with force fit and/or with substance to substance bond.

22. A roller shutter in accordance with claim 21, wherein at least one engaging element is provided with an attachment strip capable of being inserted into a respective groove-shaped receptacle extending in the longitudinal direction of the slat in order to fix the slat with positive locking.

23. A roller shutter in accordance with claim 22, wherein at least one attachment strip has a hook profile in a section plane extending vertically to the longitudinal axis and/or at least one receptacle has a profile serving to fix the hook profile with positive locking.

24. A roller shutter in accordance with claim 21, wherein at least one engaging element comprises a hook segment engaging into a hook segment arranged on an adjacent slat in a section plane extending vertically to the longitudinal axis of the slats in order to produce an articulated connection with an engaging device arranged on an adjacent slat.

25. A roller shutter in accordance with claim 21, further comprising least one sealing element extending in the longitudinal direction of the slats.

26. A roller shutter in accordance with claim 25, wherein the sealing element is arranged on the groove of a slat arranged on the side of a hook segment that is facing the exterior side of the door leaf and that the sealing element comes to rest on an adjacent slat at least in the closed position of the door leaf with a sealing area preferably having a hollow design.

27. A roller shutter in accordance with claim 25, wherein at least one sealing element is arranged on a boundary surface of a hook segment facing the exterior side of the door leaf, and specifically has a one-piece design with it, and is capable of being inserted into a gap formed between adjacent slats in the course of a pivot movement with respect to the pivot axis, thereby coming to rest on the adjacent slat.

28. A roller shutter in accordance with claim 21, further comprising a drive motor configured to operate to move the door leaf between the closed position and the opened position.

29. A roller shutter in accordance with claim 28, wherein the drive motor is coupled to the door leaf via a preferably continuous pull device.

30. A roller shutter in accordance with claim 29, wherein the pull device is coupled to the quarter of the door leaf that is trailing during the opening movement,

31. A roller shutter in accordance with claim 30, wherein the pull device is coupled to the bottommost slat of the door leaf in the closed position.

32. A roller shutter in accordance with claim 21, further comprising spirally extending guide rails serving to accommodate the lateral edges of the slats in the opened position.

33. A roller shutter in accordance with claim 21, further comprising at least one spacer element arranged on at least one slat in order to ensure a preset distance between adjacent slats in the direction of the opening movement.

34. A roller shutter in accordance with claim 33, wherein the spacer element is designed as a separate element capable of being fixed to the slat with positive locking, with force fit and/or with substance to substance bond.

35. A roller shutter in accordance with claim 34, wherein the spacer element includes at least one attachment strip capable of being inserted into a groove-shaped receptacle extending in a longitudinal direction of the slats.

36. A roller shutter in accordance with claim 35, wherein at least one attachment strip has a hook profile in a section plane extending vertically to the longitudinal axis of the slats and/or at least one receptacle has a profile serving to fix the hook profile with positive locking.

37. A roller shutter in accordance with claim 36, wherein at least one engaging element and at least one spacer element are arranged at least one edge of at least one slat.

38. A roller shutter in accordance with claim 37, wherein at least one spacer element is arranged in the longitudinal direction of the slat next to an engaging element, specifically at a lateral slat edge and/or between two engaging elements.

39. A roller shutter in accordance with claim 38 at least one engaging element and/or one spacer element is made, at least in part, of plastic.

40. A roller shutter in accordance with claim 21, wherein at least one slat is made, at least in part, of a metal, specifically aluminum and/or steel.
